(19) United States
(12) Patent Application Publication
(10) Pub. No.: US 2015/0062170 A1
(43) Pub. Date: Mar. 5, 2015

(54) SIMULATED-IMAGE MANAGEMENT SYSTEM AND METHOD FOR PROVIDING SIMULATED IMAGE OF MULTI-PROJECTION SYSTEM

(71) Applicant: CJ CGV CO., LTD., Seoul (KR)

(72) Inventors: Hwan Chul KIM, Seoul (KR); Su Ryeon KANG, Goyang-si (KR)

(73) Assignee: CJ CGV CO., LTD., Seoul (KR)

(21) Appl. No.: 14/218,104

(22) Filed: Mar. 18, 2014

(30) Foreign Application Priority Data
Sep. 3, 2013 (KR) 10-2013-0105277

(51) Int. Cl. G06T 7/00

(52) U.S. Cl. CPC G06T 7/004; G06T 2207/20221
USPC 345/634

(57) ABSTRACT

The present invention provides a simulated-image management device for providing a simulated image of a multi-projection system, the simulated-image management device including a simulated-image management unit which generates a simulated image that indirectly shows that specific image content is reproduced in a specific multi-projection theater, wherein the simulated image is an image showing that the specific image content is reproduced on a plurality of projection surfaces included in the specific multi-projection theater.

### TECHNICAL FIELD

The present invention relates to a simulated-image management system and method for providing a simulated image of a multi-projection system and, more particularly, to a system and method which can generate and manage a simulated image showing that specific image content is reproduced in a specific multi-projection theater.

### BACKGROUND ART

Conventionally, in order to reproduce images such as movies, advertisements, etc., two-dimensional images are projected on a single screen arranged in front of a theater. However, audiences can only watch two-dimensional (2D) images under such a system.

Three-dimensional (3D) image technologies for providing the audience with 3D images have recently been developed. 3D image technologies use the principle of allowing an audience to feel the 3D effect even from a flat image when different images are presented to the left and right eyes of the audience and combined in the brain. In detail, two cameras equipped with different polarizing filters are used during filming, and the audience wears glasses with polarizing filters such that different images are presented to the left and right eyes during watching.

However, while these 3D technologies can provide the audience with 3D images, the audience just watches the images reproduced on a single screen, which may reduce the degree of involvement in the images. Moreover, the direction of the 3D effect that the audience feels is limited to the direction of the single screen.

Furthermore, according to the conventional 3D technologies, the audience must wear the glasses equipped with polarizing filters during watching, which may make the audience feel inconvenient, and different images are artificially presented to the left and right eyes, which may make some sensitive audiences feel dizzy or nausea.

Therefore, a so-called “multi-projection system” which can solve the problems of the conventional projection systems based on a single screen has been proposed. The “multi-projection system” refers to a technology in which a plurality of projection surfaces are arranged around auditorium such that synchronized and unified images are reproduced on the plurality of projection surfaces, thus providing the audience with the three-dimensional effect and immersion.

Meanwhile, in order to efficiently operate the “multi-projection system”, it is necessary to simulate the operation of the “multi-projection system” in advance and to check the state in which various image contents are reproduced in the “multi-projection system” in advance. However, there was no simulation technology related to the “multi-projection system” in the past.

Therefore, there is a need to develop a technology that can meet these technical requirements.

### DISCLOSURE OF INVENTION

### Technical Problem

An object of the present invention is to provide a simulated-image management system and method which can generate and manage a simulated image showing that specific image content is reproduced in a specific multi-projection theater in advance with respect to a so-called “multi-projection system”.

### Solution to Problem

To achieve the above object, a simulated-image management device in accordance with an embodiment of the present invention may comprise a simulated-image management unit which generates a simulated image that indirectly shows that specific image content is reproduced in a specific multi-projection theater, and the simulated image may be an image showing that the specific image content is reproduced on a plurality of projection surfaces included in the specific multi-projection theater.

The simulated-image management unit may generate the simulated image by generating a virtual image of the specific multi-projection theater and overlapping the generated virtual image with the specific image content.

The virtual image may comprise a plurality of virtual projection surface images, and the plurality of virtual projection surface images may be formed with the same color or brightness as the actual projection surfaces.

The simulated-image management unit may determine the position or area, in which the specific image content is to be overlapped, based on position information of two or more projection devices installed in the specific multi-projection theater.

The simulated-image management unit may correct the specific image content based on information of the plurality of projection surfaces or two or more projection devices, which are included in the specific multi-projection theater, and generate the simulated image by overlapping the corrected specific image content with a projection surface in the virtual image.

The simulated-image management unit may correct the specific image content so as to offset differences in properties of the plurality of projection surfaces or differences in performance of the two or more projection devices.

The simulated-image management unit may receive a taken image of a simulation room from a simulation room management device and generate the simulated image using the received image.

The simulation room may comprise a plurality of projection surfaces and two or more projection devices, which are installed flexibly, and may be transformed into the same environment as the specific multi-projection theater.

In the simulation room, the arrangement of the projection surfaces, the material of the projection surfaces, or the position of the projection devices may be changed under the control of an electronic device.

The simulated-image management device may further comprise an improvement information management unit which manages improvement information of the specific multi-projection theater, which is analyzed based on the simulated image.

The improvement information management unit may generate the improvement information by analyzing the position, area, brightness, or quality of images, which are reproduced on a plurality of projection surfaces in the simulated image, either individually or relatively.

The improvement information may comprise information on the replacement of the projection surface, information on the position change of the projection surface, information on the brightness adjustment of the projection device, or information on a paint applied on the projection surface.

The improvement management unit may transmit the improvement information to a multi-projection theater management device which manages the specific multi-projection theater.

To achieve the above object, a simulated-image management method in accordance with an embodiment of the present invention may comprise the steps of: (a) receiving, at a simulated-image management device, information on specific image content and a specific multi-projection theater; and (b) generating, at the simulated-image management device, a simulated image that indirectly shows that the specific image content is reproduced in the specific multi-projection theater, and the simulated image may show that the specific image content is reproduced on a plurality of projection surface s included in the specific multi-projection theater.

### Advantageous Effects of Invention

The present invention can generate and manage a simulated image showing that specific image content is reproduced in a specific multi-projection theater in advance in which a “multi-projection system” is constructed. Therefore, it is possible to diagnose and analyze problems that may be present in the multi-projection system using the simulated image without having to project an image in an actual multi-projection theater.

Moreover, the present invention can provide information for improving the projection environment of a specific multi-projection theater (e.g., to change the position of a projection device, change the material of a projection surface, to change the arrangement of the projection surface, etc.) by analyzing the generated simulated image.

Furthermore, the present invention can correct specific image content, which is the subject of the simulation, based on information of projection surfaces or projection devices, which are installed in a specific multi-projection theater, and generate a simulated image using the corrected specific image content. Therefore, it is possible to diagnose and analyze problems of the specific multi-projection theater, which cannot be solved by the image correction, by analyzing the generated simulated image.

In addition, the present invention can generate the simulated image in conjunction with a projection device and an imaging device which are installed in a simulation room. Therefore, it is possible to generate a simulated image that is substantially the same as the actual projection state.

Additionally, the simulated image generated by the present invention can be used in various steps associated with the creation of multi-projection image content. For example, the simulated image can be used to check in advance the state in which pre-edited image content is reproduced in various steps such as post-production, pre-production, production, etc.

### BRIEF DESCRIPTION OF DRAWINGS

FIGS. 1 to 3 are diagrams showing examples of a multi-projection system.

FIG. 4 is a diagram showing the configuration of a simulated-image management system in accordance with an embodiment of the present invention.

FIG. 5 is a diagram showing the configuration of a simulated-image management device in accordance with an embodiment of the present invention.

FIG. 6 is a conceptual diagram showing an example in which a simulated-image management device in accordance with an embodiment of the present invention generates a simulated image by image overlapping.

FIG. 7 is a conceptual diagram showing an example in which a simulated-image management device in accordance with an embodiment of the present invention generates a simulated image in conjunction with a simulation room management device.

FIG. 8 is a conceptual diagram showing an example in which a simulation room management device in accordance with an embodiment of the present invention changes the arrangement of a projection surface.

FIG. 9 is a conceptual diagram showing an example in which a simulation room management device in accordance with an embodiment of the present invention changes the surface material of a projection surface.

FIG. 10 is a conceptual diagram showing an example in which a simulation room management device in accordance with an embodiment of the present invention moves a projection device.

FIG. 11 is a flowchart showing a simulated-image management method in accordance with an embodiment of the present invention.

### MODE FOR THE INVENTION

Hereinafter, a simulated-image management system and method according to the present invention will be described in detail with reference to the accompanying drawings. The following embodiments are provided only for illustrative purposes so that those skilled in the art can fully understand the spirit of the present invention, but the present invention is not limited thereby. Moreover, it is to be understood that all matters herein set forth in the accompanying drawings are to be interpreted as illustrative and may be in different forms from those actually implemented.

The simulated-image management system and method according to the present invention, which will be described below, is an invention relating to a so-called “multi-projection system”, which can generate and manage a simulated image that indirectly shows that specific image content is reproduced in a specific multi-projection theater.

Therefore, the “multi-projection system” that is the basis of the present invention will now be described briefly, and then the features of the present invention will be described in detail later.

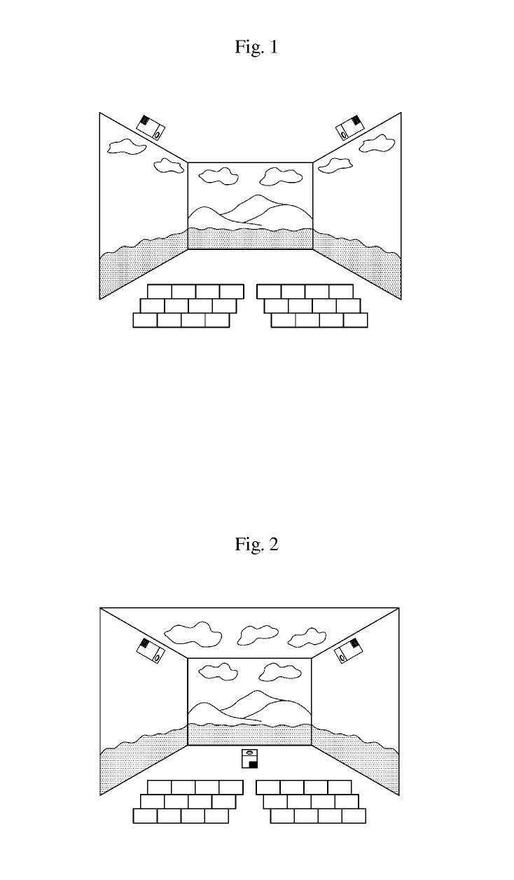

Next, the multi-projection system that is the basis of the present invention will be described with reference to FIGS. 1 to 3.

The multi-projection system that is the basis of the present invention refers to a system which can provide synchronized images on a plurality of projection surfaces installed in a single theater and maximize the reality, three-dimensional effect, and immersion that the audience can feel in these environments. That is, the multi-projection system refers to a system in which a plurality of projection surfaces are provided in a single theater to provide the audience with synchronized images on the plurality of projection surfaces.

The plurality of projection surfaces are provided for multi-projection in a single theater. A plurality of images may be reproduced on the plurality of projection surfaces. Here, it is preferable that the images reproduced on the plurality of projection surfaces are synchronized with each other and generally create a unified image. That is, while different images may be reproduced on the respective projection surfaces, it is preferable that the different images are synchronized with each other to create a unified image when viewed over the entire projection surface. Of course, depending on the situations, an independent image may be reproduced on each projection surface or images may be reproduced only on some of the projection surfaces.

Meanwhile, the plurality of projection surfaces may reproduce images using all of the plurality of projection surfaces or using only some of the plurality of projection surfaces. For example, the plurality of projection surfaces may provide a state in which an image is reproduced only on a specific projection surface (state 1), a state in which images are reproduced only on some of the plurality of projection surfaces (state 2), and a state in which images are reproduced on all of the plurality of projection surfaces (state 3), and these states 1 to 3 may be implemented alternately during projection of image content.

Moreover, the plurality of projection surfaces may be arranged so as not to be parallel to each other. According to the prior art, an image is projected only on a screen placed in front of a theater such that the audience watches the image reproduced on the two-dimensional screen or a 3D technology is applied to the image itself reproduced on a plane. On the contrary, in the multi-projection system that is the basis of the present invention, the plurality of projection surfaces are three-dimensionally arranged so as not to be parallel to each other, and thus it is possible to provide the audience with a three-dimensional image with high three-dimensional effect and immersion through the three-dimensionally arranged plurality of projection surfaces without applying the 3D technology to the image itself.

Furthermore, it is preferable that the plurality of projection surfaces are arranged to surround the auditorium in the theater. Therefore, the audience can feel as if they are in a space created by the synchronized images reproduced on the plurality of projection surfaces, and thus the three-dimensional effect, immersion, and virtual reality that the audience feels can be maximized.

In addition, the angle between the projection surfaces is not limited to a specific angle, and the plurality of projection surfaces may be arranged at various angles as long as the audience can feel the three-dimensional effect.

Additionally, the plurality of projection surfaces may be arranged to be adjacent to each other or to be spaced from each other and, even in this case, it is preferable that the plurality of projection surfaces are arranged to surround the auditorium.

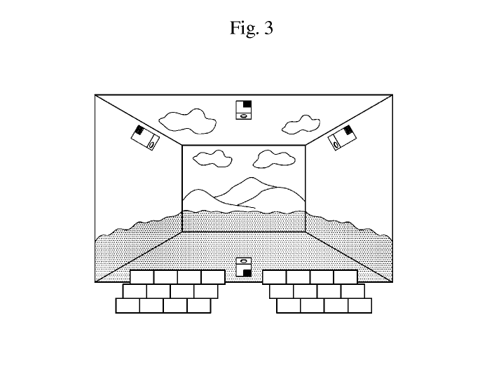

FIG. 1 shows an example in which the plurality of projection surfaces are arranged on the front, left, and right sides with respect to the audience seats, FIG. 2 shows an example in which the plurality of projection surfaces are arranged on the front, left, right, and top sides with respect to the audience seats, and FIG. 3 shows an example in which the plurality of projection surfaces are arranged on the front, left, right, top, and bottom sides with respect to the audience seats.

Moreover, the plurality of projection surfaces may comprise various types of projection surfaces such as a screen, wall, etc. and may comprise different types of projection surfaces at the same time.

Furthermore, the images projected on the plurality of projection surfaces may be projected by two or more projection devices installed in the theater, and these two or more projection devices may be implemented by including an optical system and a heating unit in various manners. For example, the projection devices may be implemented in various ways, such as by using a cathode ray tube (CRT), using a liquid crystal display (LCD), by digital light processing (DLP) using a digital micromirror device (DMD) chip, by liquid crystal on silicon (LCoS), etc. as well as various other ways. In addition, the two or more projection devices may be electrically connected to an image management device and then integratedly controlled by the image management device and may project images on the plurality of projection surfaces under the control of the image management device.

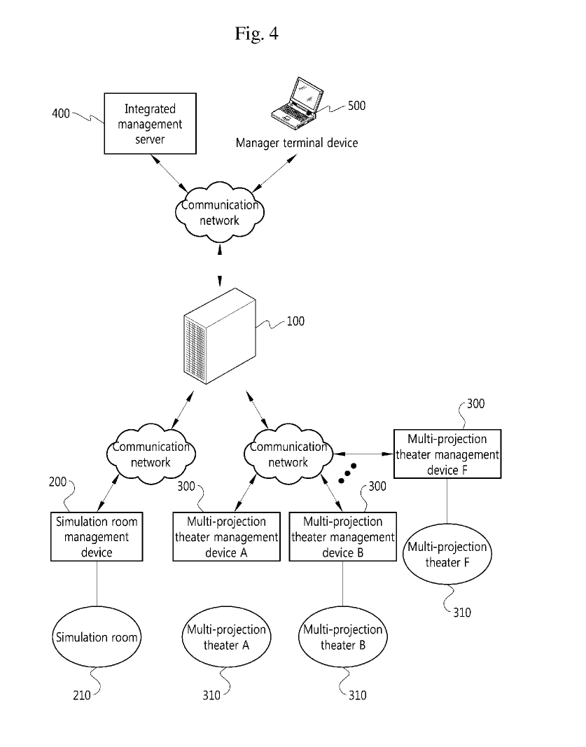

Next, a simulated-image management system in accordance with an embodiment of the present invention will be described with reference to FIG. 4.

Referring to FIG. 4, the simulated-image management system in accordance with an embodiment of the present invention may comprise a simulated-image management device 100 which generates a simulated image that indirectly shows that specific image content is reproduced in a specific multi-projection theater and may further comprise a simulation room management device 200, a multi-projection theater management device 300, and an integrated management server 400 or a manager terminal device 500, which are connected to the simulated-image management device 100 through a communication network.

The simulated-image management device 100 generates a simulated image that indirectly shows that specific image content is reproduced in a specific multi-projection theater.

Here, the specific multi-projection theater and the specific image content, which are the subject of the simulated image, may be determined based on information transmitted from the outside, preferably based on information transmitted from the integrated management server 400 or the manager terminal device 500. For example, the integrated management server 400 or the manager terminal device 500 may transmit screening schedule information indicating that specific image content (e.g., Superstar K image) is scheduled to be screened in a specific multi-projection theater (e.g., multi-projection theater A) to the simulated-image management device 100. In this case, the simulated-image management device 100 may generate the simulated image based on identification information of the specific image content (e.g., Superstar K image) and identification information of the specific multi-projection theater (e.g., multi-projection theater A) which are included in the screening schedule information. Meanwhile, the specific multi-projection theater and the specific image content may be determined based on information input through an input unit included in the simulated-image management device 100.

Moreover, when the specific multi-projection theater and the specific image content which are the subject of the simulated-image are determined, the simulated-image management device 100 collects information on the determined specific multi-projection theater and specific image content. Specifically, the simulated-image management device 100 collects system construction information of the specific multi-projection theater (e.g., information on the number of a plurality of projection surfaces, arrangement information of the plurality of projection surfaces, material information of the plurality of projection surfaces, surface morphology information of the plurality of projection surfaces, color information of the plurality of projection surfaces, brightness information of the plurality of projection surfaces, reflectance information of the plurality of projection surfaces, information on a projection device for projecting images on the plurality of projection surfaces, etc.) image data of the specific image content, etc. and these information may be collected from a database included in the simulated-image management device 100 or from the outside through a communication network. Meanwhile, the simulated-image management device 100 may receive a taken image of the specific multi-projection theater through the communication network. In this case, the simulated-image management device 100 may analyze the received image and then obtain system construction information of the specific multi-projection theater (e.g., installation information of a plurality of projection surfaces, installation information of two or more projection devices, etc.).

Furthermore, the simulated-image management device 100 may generate the simulated image in various ways. Specifically, the simulated-image management device 100 may generate the simulated image (1) using a virtual image of the specific multi-projection theater or (2) in conjunction with a simulation room which can implement the same environment as the specific multi-projection theater.

In addition, the simulated-image management device 100 may correct the specific image content and use the corrected specific image content for the generation of the simulated image. Here, the simulated-image management device 100 may correct the specific image content based on information on the specific multi-projection theater (e.g., information on a plurality of projection surfaces, information on two or more projection devices, etc.). In this case, it is preferable that the correction of the specific image content is performed to offset differences in properties of the plurality of projection surfaces (e.g., brightness, color, image quality, etc.) or differences in performance of the two or more projection devices (e.g., lamp output, resolution, etc.) (so as to implement synchronized and unified images on the plurality of projection surfaces).

Additionally, the simulated-image management device 100 may transmit the corrected specific image content to the specific multi-projection theater. Specifically, the simulated-image management device 100 may transmit the corrected image of the specific image content to a management device of the specific multi-projection theater such that the management device of the specific multi-projection theater can project the specific image content without having to perform any image correction.

Also, the simulated-image management device 100 may manage improvement information of the specific multi-projection theater obtained by analyzing the simulated image. Here, the improvement information refers to information with which the projection environment of the specific multi-projection theater can be improved and with which problems identified from the simulated image can be solved. Moreover, the improvement information may contain a variety of information for improving the multi-projection environment, such as information on the position change of the projection surface, information on the brightness adjustment of the projection device, replacement information of the projection surface, information on a paint applied on the projection surface, etc. Meanwhile, the analysis process of the simulated image may preferably be performed by the simulated-image management device 100, but may also be performed by any device other than the simulated-image management device 100. For example, the simulated-image management device 100 may transmit the generated simulated image to the integrated management server 400 or the manager terminal device 500 and then receive the improvement information from the integrated management server 400 or the manager terminal device 500.

Meanwhile, the simulated-image management device 100 may be implemented with various electronic devices that can transmit and receive information through a communication network and may preferably be implemented in the form of a server that can be connected to the manager terminal device 500, the integrated management server 400, the multi-projection theater management device 300, and the simulation room management device 200 through a wired or wireless communication network.

The integrated management server 400 or the manager terminal device 500 may be connected to the simulated-image management device 100 through a communication network and may perform various operations associated with the generation or management of the simulated image in conjunction with the simulated-image management device 100. For example, the integrated management server 400 or the manager terminal device 500 may transmit screening schedule information indicating that specific image content (e.g., Superstar K image) is scheduled to be screened in a specific multi-projection theater (e.g., multi-projection theater A) to the simulated-image management device 100 and, at the same time, may instruct the simulated-image management device 100 to generate the simulated image. Moreover, the integrated management server 400 or the manager terminal device 500 may receive generated simulation information and then generate the improvement information. Furthermore, the integrated management server 400 or the manager terminal device 500 may retransmit the improvement information to the simulated-image management device 100 or directly to the multi-projection theater management device 300.

Meanwhile, the manager terminal device 500 may be configured with various electronic devices such as a tablet PC, smartphone, desktop PC, notebook PC, PDA, etc. as well as various other electronic devices that can transmit and receive data through a communication network. Moreover, the integrated management server 400 may be configured with various electronic devices that can transmit and receive information through a communication network and may preferably be implemented in the form of a server that can be connected to the simulated-image management device 100 through a wired or wireless communication network.

The multi-projection theater management device 300 is configured to control the multi-projection system constructed in a multi-projection theater 310 and may be installed in each multi-projection theater (e.g., multi-projection theater A, multi-projection theater b, . . . , multi-projection theater F, etc.). The multi-projection theater management device 300 may control two or more projection devices, an imaging device, etc. which are installed in the multi-projection theater 310 and may manage a variety of information on the multi-projection theater 310 (e.g., information on a plurality of projection information, information on two or more projection devices, etc.). Moreover, the multi-projection theater management device 300 may be connected to the simulated-image management device 100 through a communication network and may perform various operations associated with the generation or management of the simulated image in conjunction with the simulated-image management device 100. For example, the multi-projection theater management device 300 may transmit information (e.g., information on a plurality of projection information, information on two or more projection devices, a taken image, etc.), which can be used for the generation of the simulated image, to the simulated-image management device 100 and receive improvement information or corrected image content, etc. from the simulated-image management device 100. Meanwhile, the multi-projection theater management device 300 may be implemented with various electronic devices that can transmit and receive information through a communication network and may preferably be implemented in the form of a server that can be connected to the simulated-image management device 100 through a wired or wireless communication network.

The simulation room management device 200 is configured to control various devices (e.g., a plurality of projection surfaces, two or more projection devices, an imaging device, etc.) installed in a simulation room 210 and may be installed inside or outside the simulation room 210. Here, the simulation room 210 can easily change its structure and thus can selectively implement projection environments of various multi-projection theaters (e.g., multi-projection theater A, multi-projection theater b, . . . , multi-projection theater F, etc.). For example, the simulation room 210 may selectively implement projection environments of various multi-projection theaters by means of a plurality of projection surfaces and two or more projection surfaces, which are installed flexibly.

The simulation room management device 200 may control the operation of the projection devices installed in the simulation room 210 and may manage images projected by the projection devices. Moreover, the simulation room management device 200 may control the operation of an imaging device installed in the simulation room 210 and may manage images taken by the imaging device.

Moreover, the simulation room management device 200 may be connected to the simulated-image management device 100 through a communication network and may perform various operations associated with the generation or management of the simulated image in conjunction with the simulated-image management device 100. For example, the simulation room management device 200 may generate a realistic simulated image in conjunction with the simulated-image management device 100. This operation will now be described in more detail. (1) First, the simulated-image management device 100 transmits simulation information to the simulation room management device 200. Here, the simulation information may contain system construction information of a specific multi-projection theater (e.g., information on a plurality of projection surfaces, information on two or more projection devices, etc.) and image data information of specific image content. (2) When receiving the simulation information, the simulation room management device 200 changes the internal environment of the simulation room 210 to be the same as the internal environment of the specific multi-projection theater. Specifically, the simulation room management device 200 controls the devices in the simulation room 210 based on the received system construction information of the specific multi-projection theater, thus changing the internal structure of the simulation room 210. (3) When the internal environment of the simulation room 210 is the same as the internal environment of the specific multi-projection theater, the simulation room management device 200 projects the specific image content on the plurality of projection surfaces. Moreover, the simulation room management device 200 takes an image, which shows that the specific image content is reproduced, by means of the imaging device. (4) After these processes, the simulation room management device 200 transmits the taken image to the simulated-image management device 100, and the simulated-image management device 100 generates a simulated image based on the received image.

Meanwhile, the simulation room management device 200 may be implemented with various electronic devices that can transmit and receive information through a communication network and may preferably be implemented in the form of a server that can be connected to the simulated-image management device 100 through a wired or wireless communication network.

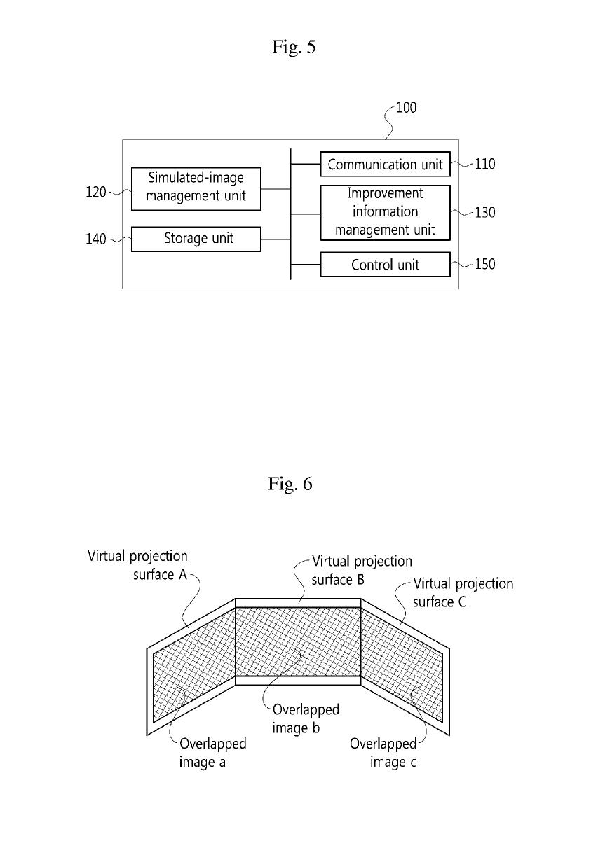

Next, the simulated-image management device 100 will be described in more detail with reference to FIGS. 5 to 7.

Referring to FIG. 5, the simulated-image management device 100 may comprise a communication unit 110 which receives information on specific image content and a specific multi-projection theater, a storage unit 140 in which a variety of information such as the information transmitted and received through the communication unit 110, information on the simulated image, etc. are stored, a simulated-image management unit 120 which generates a simulated image that indirectly shows that the specific image content is reproduced in the specific multi-projection theater, an improvement information management unit 130 which manages improvement information of the specific multi-projection theater, which is analyzed based on the simulated image, and a control unit 150 which controls the operation of the communication unit 110, the storage unit 140, the simulated-image management unit 120, and the improvement information management unit 130.

Here, the simulated image is an image showing that the specific image content is reproduced on a plurality of projection surfaces included in the specific multi-projection theater.

The communication unit 110 is configured to transmit and receive information to and from various devices such as the integrated management server 400, the manager terminal device 500, the multi-projection theater management device 300, the simulation room management device 200, etc.

The communication unit 110 may be implemented with wired or wireless communication devices including a LAN module, WLAN module, etc. and may transmit and receive information through various communication networks including a TCP/IP network and through various protocols.

The storage unit 140 temporarily or permanently stores a variety of information such as the information transmitted and received through the communication unit 110, information on the simulated image, etc. For example, the storage unit 140 may store a variety of information on the operation of the simulated-image management device 100, such as identification information of a specific multi-projection theater and specific image content, which are the subject of the simulation, system construction information of various multi-projection theaters (e.g., information on the number of a plurality of projection surfaces, arrangement information of the plurality of projection surfaces, material information of the plurality of projection surfaces, brightness information of the plurality of projection surfaces, surface morphology information of the plurality of projection surfaces, color information of the plurality of projection surfaces, reflectance information of the plurality of projection surfaces, information on a projection device for projecting images on the plurality of projection surfaces, etc.), image data of various image contents, information on virtual image generation, information on image correction, taken images transmitted from the simulation room management device 200, improvement information obtained by analyzing the simulated image, etc.

Meanwhile, the storage unit 140 may be implemented with various electronic devices and may preferably be implemented with a memory device.

The simulated-image management unit 120 generates a simulated image that indirectly shows that specific image content (e.g., Superstar K image) is reproduced in a specific multi-projection theater (e.g., multi-projection theater A).

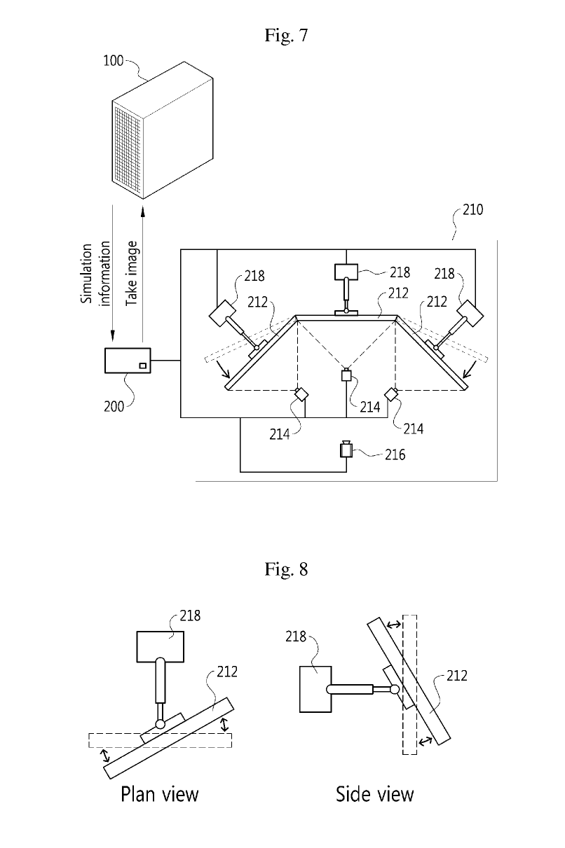

The simulated-image management unit 120 may generate the simulated image in various ways. Specifically, the simulated-image management unit 120 may generate the simulated image by (1) image synthesis (FIG. 6) or (2) in conjunction with the simulation room 210 which can implement the same environment as the specific multi-projection theater (FIG. 7).

First, the generation of the simulated image by the image synthesis method will now be described.

The simulated-image management unit 120 may generate the simulated image by generating a virtual image of the specific multi-projection theater (which may preferably be generated in the form of a 3D image that indirectly shows the state of the specific multi-projection theater) and overlapping the generated virtual image with the specific image content.

Here, the virtual image of the specific multi-projection theater is generated based on the system construction information of the specific multi-projection theater. That is, the simulated-image management unit 120 generates the virtual image of the specific multi-projection theater based on the arrangement information of the plurality of projection surfaces, brightness information of the plurality of projection surfaces, color information of the plurality of projection surfaces, reflectance information of the plurality of projection surfaces, surface morphology information of the plurality of projection surfaces, information on an internal structure (e.g., a speaker, etc.) installed on the surface of the projection surface, etc, which are included in the system construction information of the specific multi-projection theater. Therefore, the generated virtual image may contain a plurality of virtual projection surface images, and the plurality of virtual projection surface images may be formed with the same brightness, surface morphology, color, and reflectance as the projection surfaces actually installed in the specific multi-projection theater and include the same surface structure (e.g., a speaker, etc.).

When the virtual image of the specific multi-projection theater is generated, the simulated-image management unit 120 overlaps the generated plurality of virtual projection surface images with the specific image content. Here, the simulated-image management unit 120 overlaps the images based on the system construction information of the specific multi-projection theater, in particular based on installation information of two or more projection devices in the specific multi-projection theater and surface information of a plurality of virtual projection surfaces. Specifically, the simulated-image management unit 120 determines the position and area, in which the image content is to be overlapped, based on the three-dimensional position of each projection device, the projection angle and direction of each projection device, the distance from each projection device to the projection surface, the surface morphology of the projection surface on which each projection device projects an image, the structure installed on the projection surface on which each projection device projects an image, etc. and overlaps the images in the determined position and area.

Next, the generation of the simulated image in conjunction with the simulation room 210 will now be described.

The simulated-image management unit 120 may generate the simulated image in conjunction with the simulation room 210, other than the image synthesis method. Specifically, the simulated-image management unit 120 may generate the simulated image by transmitting simulation information to the 200 and receiving a taken image of the simulation room 210.

Here, the simulation information may contain the system construction information of the specific multi-projection theater (e.g., information on a plurality of projection surfaces, information on two or more projection devices, etc.) and the image data information of the specific image content.

Moreover, the simulation room 210 has the same projection environment as the specific multi-projection theater. Specifically, the simulation room 210 comprises the same projection surfaces (e.g., the same arrangement, number, material, etc.) as the specific multi-projection theater and the same projection devices (e.g., the same three-dimensional position, distance to the projection surface, etc.) as the specific multi-projection theater. Therefore, the simulation room 210 having the same projection environment as the specific multi-projection theater takes an image showing that the specific image content is reproduced, thus generating the simulated image.

Meanwhile, the simulation room 210 may comprise projection surfaces and projection surfaces, which are installed flexibly, and may be transformed into a state provided with the same environment as the specific multi-projection theater by means of these components. Moreover, the simulation room 210 may be configured in a manner that the structural change of the simulation room 210 (e.g., a change in arrangement of the projection surfaces, a change in material of the projection surfaces, a change in position of the projection device, etc.) is controlled by an electronic device, and thus the structural change of the simulation room 210 can be automated by this configuration.

Although the two methods in which the simulated-image management unit 120 generates the simulated image have been described above independently, the simulated-image management unit 120 may generate two simulated images by employing the two methods at the same time. Therefore, in this case, since two types of simulated images are generated by different methods, a double check for system inspection may be possible.

Meanwhile, the simulated-image management unit 120 may correct the specific image content and use the corrected specific image content for the generation of the simulated image.

Here, the simulated-image management unit 120 may correct the specific image content based on information of the specific multi-projection theater (e.g., information on a plurality of projection surfaces, information on two or more projection devices, etc.). In this case, it is preferable that the correction of the specific image content is performed to offset differences in properties of the plurality of projection surfaces (e.g., brightness, color, image quality, material, structure etc.) or differences in performance of the two or more projection devices (e.g., lamp output, resolution, etc.) (so as to implement synchronized and unified images on the plurality of projection surfaces).

Therefore, since the simulated image using the specific image content, in a state where the image correction is completed, is generated, the simulated-image management unit 120 can diagnose and analyze problems, which cannot be solved by the image correction, by analyzing the generated simulated image.

For reference, the correction of the specific image content performed by the simulated-image management unit 120 based on the information on the plurality of projection surfaces installed in the specific multi-projection theater will now be described. The simulated-image management unit 120 may correct specific image content based on the information on the properties of the plurality of projection surfaces installed in the specific multi-projection theater. Specifically, the simulated-image management unit 120 may correct the specific image content so as to offset the differences in properties based on the information on the differences in properties (such as a difference in color, a difference in brightness, a difference in reflectivity, a difference in material, a difference in structure, etc.) between the projection surfaces.

Representatively, the correction based on the information on the difference in color between the projection surfaces will now be described (the process which will be described below can, of course, be applied to the correction based on the difference in brightness, difference in reflectivity, difference in material, difference in structure, etc.). First, the simulated-image management device 100 may calculate information on a difference in chromaticity between the projection surfaces based on chromaticity information of the respective projection surfaces. In detail, the simulated-image management device 100 may set a single reference projection surface and then calculate information on a relative difference in chromaticity of each projection surface. For example, the information on the relative difference in chromaticity is calculated in such a manner that “projection surface A has a red (R) color level 50 higher than that of the reference projection surface, a green (G) color level 40 higher than that of the reference projection surface, and a blue (B) color level the same as that of the reference projection surface”. After the information on the difference in chromaticity of the respective projection surfaces is calculated in this manner, the images may be corrected based on the calculated information in such a manner so as to “reduce the R color level of the image projected on projection surface A by 50, reduce the G color level by 40, and maintain the B color level”, for example. Therefore, the difference in chromaticity of the projection surfaces can be offset.

Meanwhile, the analysis of the differences in properties of the plurality of projection surfaces may be performed in various ways other than the method of setting the reference projection surface. For example, it is possible to calculate representative values (e.g., mean values, median values, mode values, etc.) for the properties of the plurality of projection surfaces and then analyze the relative difference in properties based on the calculated representative values.

Moreover, the correction of the specific image content performed by the simulated-image management unit 120 based on the information on the two or more projection devices installed in the specific multi-projection theater will now be described. The simulated-image management unit 120 may correct the specific image content based on the information on the properties of the projection devices installed in the specific multi-projection theater. Specifically, the simulated-image management unit 120 may correct the specific image content so as to offset the differences in performance based on the information on the differences in performance (e.g., a difference in contrast, difference in brightness, difference in resolution, difference in image quality due to physical distance, etc.) between the two or more projection devices.

Representatively, the correction based on the information on the difference in brightness between the two or more projection devices will now be described (the process which will be described below can, of course, be applied to the correction based on the difference in contrast, difference in resolution, difference in image quality etc.). First, the simulated-image management unit 120 may offset the difference in brightness between the projection devices by correction. For example, if it is assumed that the brightness of projection device A is 500 ANSI Lumens, the brightness of projection device B is 1000 ANSI Lumens, and the brightness of projection device C is 1500 ANSI Lumens, this difference in brightness may be offset by the image correction. In detail, the brightness ratio of the images projected by projection devices A, B, and C is corrected to 3:2:1, thus offsetting the heterogeneity of the images which may occur due to the difference in brightness between the devices.

The improvement information management unit 130 is configured to manage improvement information of the specific multi-projection theater, which is analyzed based on the simulated image. Here, the improvement information refers to information for improving the projection environment of the specific multi-projection theater and including measures to solve problems identified from the simulated image. For example, the improvement information may contain information on the replacement of the projection surface, information on the position change of the projection surface, information on the brightness adjustment of the projection device, information on a paint applied on the projection surface, etc. Meanwhile, as mentioned above, the improvement information may be generated by the integrated management server 400 or the manager terminal device 500, but may preferably be generated directly by the improvement information management unit 130.

The generation of the improvement information by the improvement information management unit 130 will now be described. The improvement information management unit 130 analyzes the position, area, brightness, quality, etc. of images, which are reproduced on a plurality of projection surfaces in the simulated image, either individually or relatively and generate the improvement information based on the image analysis. For example, when the position of a specific image reproduced on a specific projection surface deviates from its original position up and down or left and right, the improvement information management unit 130 may generate improvement information for instructing to move the projection device for projecting the image on the specific projection surface. Moreover, when the image reproduced on the specific projection surface is brighter than the images reproduced on other projection surfaces, the improvement information management unit 130 may generate improvement information for instructing to reduce the light intensity (e.g., lamp output) of the projection device for projecting the image on the specific projection surface. Furthermore, when the distortion (e.g., color, quality, etc.) of the image reproduced on the specific projection surface is more serious than the images reproduced on other projection surfaces, the improvement information management unit 130 may generate improvement information for instructing to replace the specific projection surface. In addition, when the definition of the image reproduced on the specific projection surface is very lower than that of the images reproduced on other projection surfaces, the improvement information management unit 130 may generate improvement information for instructing to apply a paint on the specific projection surface. Additionally, when the area of the image reproduced on the specific projection surface is larger or smaller than that of the images reproduced on other projection surfaces, the improvement information management unit 130 may generate improvement information for instructing to move the projection device for projecting the image on the specific projection surface (to be adjacent to or remote from the projection surface). Also, the improvement information management unit 130 may generate a variety of improvement information other than the above-described improvement information.

Meanwhile, the improvement information management unit 130 may transmit the generated improvement information to the multi-projection theater management device 300 that manages the specific multi-projection theater such that the improvement information can be used for improving the environment of the specific multi-projection theater.

The control unit 150 is configured to control various operations of the communication unit 110, the simulated-image management unit 120, the improvement information management unit 130, and the storage unit 140. The control unit 150 may be implemented with various arithmetic units.

Next, a specific embodiment of the simulation room 210, which may generate the simulated image in conjunction with the simulated-image management unit 120, will be described with reference to FIGS. 7 to 10.

Referring to FIG. 7, the simulation room 210 may comprise a plurality of projection surfaces 212, each having a transformable structure, and two or more projection devices 214 which project synchronized images on the plurality of projection surfaces 212 and move horizontally or vertically.

Moreover, the plurality of projection surfaces 212 and the two or more projection devices 214 may selectively implement the same environment as the projection environment of a specific multi-projection theater and thus may indirectly show that specific image content is reproduced in the specific multi-projection theater.

The plurality of projection surfaces 212 may have a transformable structure to implement the projection surface of various multi-projection theaters. For example, the plurality of projection surfaces 212 may have a structure in which the surface material, arrangement, etc. of each projection surface 212 can be transformed.

Referring to FIGS. 7 and 8, the projection surface 212 may be installed in the simulation room 210 in a non-fixed manner and may be connected to a driving device 218. Here, the driving device 218 may move the projection surface 212 based on power supplied from a power unit. Specifically, the driving device 218 may move or rotate the projection surface 212 in various directions. Therefore, the driving device 218 can change the arrangement position, arrangement angle, etc. of each projection surface 212 by means of this operation. Meanwhile, the driving device 218 may comprise various motors and may be connected to the projection surface 212 by means of a ball joint, for example, which allows rotational movement.

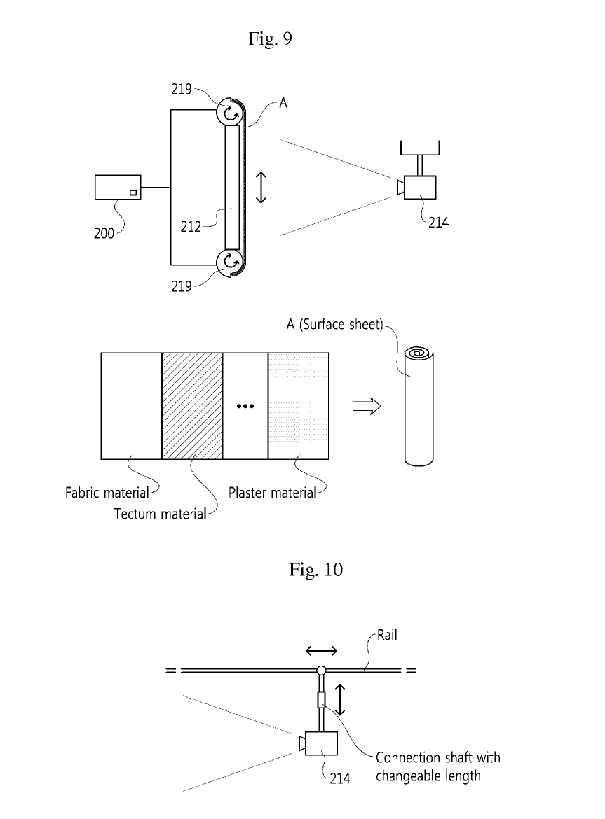

Moreover, referring to FIG. 9, the projection surface 212 may comprise a surface replacement device 219 that changes the surface materials of the projection surface. Here, the surface replacement device 219 may comprise a surface sheet in the form of a roll which can sequentially implement various materials such as fabric, tectum, plaster, etc. and may selectively change the surface materials of the projection surface by means of the surface sheet in the form of a roll. For example, the surface replacement device 219 may wind or unwind the surface sheet in the form of a roll using rotation devices installed on both sides of the projection surface 212 as shown in FIG. 9, and the surface of the projection surface 212 can be covered with the sheets of various materials by means of this operation.

Furthermore, the two or more projection devices 214 may also have a transformable structure to implement the projection devices of various multi-projection theaters. For example, the two or more projection devices 214 may be configured to move horizontally or vertically and move to various places in the simulation room 210.

Referring to FIG. 10, the projection device 214 may be configured to move along a rail installed on the ceiling of the simulation room 210. Therefore, the projection device 214 can freely move horizontally by the movement along the rail. Meanwhile, a shaft connecting the rail and the projection device 214 may be configured to adjust its length, and thus the projection device 214 can also freely move vertically by the adjustment of the length of the connection shaft.

Meanwhile, the simulation room 210 may be connected to the simulation room management device 200 which generally controls the simulation room 210.

The simulation room management device 200 controls various devices included in the simulation room 210. In particular, the simulation room management device 200 may control the operation of the projection device 214, the driving device 218, and the surface replacement device 219.

Moreover, the simulation room management device 200 may control an imaging device 216, which may be installed in the simulation room 210, and may transmit images taken by the imaging device 216 through a communication network.

Meanwhile, as also mentioned above, the simulation room management device 200 may be implemented in a server that can transmit and receive information through a communication network.

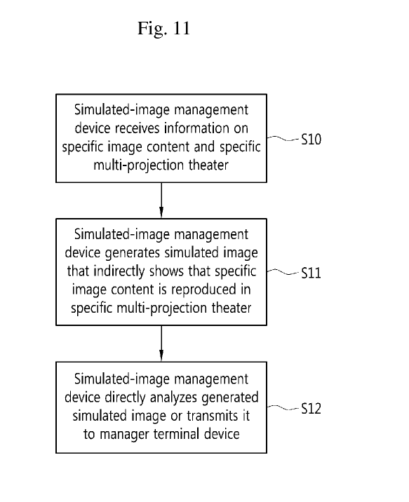

Next, a simulated-image management method in accordance with an embodiment of the present invention will be described with reference to FIG. 11.

Referring to FIG. 11, the simulated-image management method in accordance with an embodiment of the present invention may comprise the step of receiving, at a simulated-image management device, information on specific image content and a specific multi-projection theater (S10).

After step (S10), the simulated-image management device may generate a simulated image that indirectly shows that the specific image content is reproduced in the specific multi-projection theater (S11).

After step (S11), the simulated-image management device may directly analyze the generated simulated image or may transmit the generated simulated image to an integrated management server or a manager terminal device (S12).

Meanwhile, the simulated-image management method may be implemented in the form of a program and then stored in a recording medium readable by an electronic device or transmitted and received through a communication network. Moreover, the simulated-image management method implemented in the form of a program may be temporarily or permanently stored in various electronic devices.

Moreover, the above-described simulated-image management method is in a different category from the simulated-image management system, but may have substantially the same features as the simulated-image management system. Therefore, although the simulated-image management method has not been described in detail to avoid repetitive description, the above-described features associated with the simulated-image management system may also be applied to the simulated-image management method.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

1. A simulated-image management device comprising a simulated-image management unit which generates a simulated image that indirectly shows that specific image content is reproduced in a specific multi-projection theater,
wherein the simulated image is an image showing that the specific image content is reproduced on a plurality of projection surfaces included in the specific multi-projection theater.

2. The simulated-image management device of claim 1, wherein the simulated-image management unit generates the simulated image by generating a virtual image of the specific multi-projection theater and overlapping the generated virtual image with the specific image content.

3. The simulated-image management device of claim 2, wherein the virtual image comprises a plurality of virtual projection surface images, the plurality of virtual projection surface images being formed with the same color or brightness as the actual projection surfaces.

4. The simulated-image management device of claim 2, wherein the simulated-image management unit determines the position or area, in which the specific image content is to be overlapped, based on position information of two or more projection devices installed in the specific multi-projection theater.

5. The simulated-image management device of claim 2, wherein the simulated-image management unit corrects the specific image content based on information of the plurality of projection surfaces or two or more projection devices, which are included in the specific multi-projection theater, and generates the simulated image by overlapping the corrected specific image content with a projection surface in the virtual image.

6. The simulated-image management device of claim 5, wherein the simulated-image management unit corrects the specific image content so as to offset differences in properties of the plurality of projection surfaces or differences in performance of the two or more projection devices.

7. The simulated-image management device of claim 1, wherein the simulated-image management unit receives a taken image of a simulation room from a simulation room management device and generates the simulated image using the received image.

8. The simulated-image management device of claim 7, wherein the simulation room comprises a plurality of projection surfaces and two or more projection devices, which are installed flexibly, and is transformed into the same environment as the specific multi-projection theater.

9. The simulated-image management device of claim 8, wherein in the simulation room, the arrangement of the projection surfaces, the material of the projection surfaces, or the position of the projection devices is changed under the control of an electronic device.

10. The simulated-image management device of claim 1, further comprising an improvement information management unit which manages improvement information of the specific multi-projection theater, which is analyzed based on the simulated image.

11. The simulated-image management device of claim 10, wherein the improvement information management unit generates the improvement information by analyzing the position, area, brightness, or quality of images, which are reproduced on a plurality of projection surfaces in the simulated image, either individually or relatively.

12. The simulated-image management device of claim 10, wherein the improvement information comprises information on the replacement of the projection surface, information on the position change of the projection surface, information on the brightness adjustment of the projection device, or information on a paint applied on the projection surface.

13. The simulated-image management device of claim 10, wherein the improvement management unit transmits the improvement information to a multi-projection theater management device which manages the specific multi-projection theater.

14. A simulated-image management method comprising the steps of:
(a) receiving, at a simulated-image management device, information on specific image content and a specific multi-projection theater; and
(b) generating, at the simulated-image management device, a simulated image that indirectly shows that the specific image content is reproduced in the specific multi-projection theater,
wherein the simulated image shows that the specific image content is reproduced on a plurality of projection surface s included in the specific multi-projection theater.
